(19) United States
(12) Patent Application Publication
(10) Pub. No.: US 2005/0010547 A1
(43) Pub. Date: Jan. 13, 2005

(54) Method and apparatus for managing identity information on a network

(75) Inventors: Rocco W. Carinci, Cumberland (CA); James A. Benedict, Ottawa (CA); Keith K. Trudell, Toronto (CA); Joseph J. Waddington, Nepean (CA)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 10/616,561

(22) Filed: Jul. 10, 2003

(51) Int. Cl. G06F 7/00

(52) U.S. Cl. 707/1

(57) ABSTRACT

A centralized identity management service includes a dynamically configured client interface that communication with a directory assess daemon. The data access daemon processes and fulfils requests by communicating with third party databases. A data access layer is interposed between the data access daemon and databases to allow the directories to be modified without affecting the data access daemon. Providing a self-configuring user interface facilitates rapid creation of network services and allows the services to be modified without manually reconfiguring the user interface. Common data format schemas facilitates deployment of new services on the network by allowing services to be defined to take advantage of the features provided by the identity management infrastructure.

### BACKGROUND OF THE INVENTION

1. Field of the Invention

The present invention relates to computer and communications networks and, more particularly, to a method and apparatus for managing identity information on a network.

2. Description of the Related Art

Communications networks contain many services, such as e-mail, remote access, and voice mail, designed to facilitate one or more aspects of an user's interaction on the network. These services typically need to discern between users on the network, as different users may have different privileges on the service and may be provisioned with different levels of access to the service. To discern between users, an identity management system is instantiated and associated with the service to enable the service to maintain identity information for authorized users of the service. The information associated with an user's interaction on a network will be referred to herein as identity information, which may include aspects such as access and privacy control information, password information, authentication, authorization, and attribute information, resource provisioning information, and other information that governs the user's access to and interactions on the network. As communications networks proliferate, and the services offered on the networks increase, management of user identity information on the network has become increasingly important.

Conventionally, identity information management has been performed by the network resources themselves. For example, an e-mail server may have a list of users, passwords, and attributes or access information associated with those users. Maintaining each of these systems separately is a tedious and resource intensive task. Additionally, creating a separate identity management system for each new system, as well as a way to display the identity information to users of the system, is time and resource intensive.

Networks are rapidly changing to accommodate new technology and new services demanded by users. For example, users may require access to the network through multiple access methods, and may have differing privilege levels depending on who they are and how they accessed the network. Each aspect governing a users' interaction on the network needs to be accounted for by the identity management systems associated with the services instantiated on the network. In a complex network having hundreds of services and multiple domains, maintaining identity information across all the services and domains has become increasingly expensive. Additionally, propagation of changes to identity information may take a considerable amount of resources and time, thus presenting a security issue where, for example, an user is terminated and network privileges are to be revoked.

Creating an identity management system for each new system as it is deployed on the network contributes to a time delay in implementing new services. Where the service sought to be deployed is a revenue generating service, such as a service on a communications network, or where the service is expected to be deployed in an environment where time to market is important, it would be advantageous not to be required to create, debug, and perform quality control checks on an identity management service prior to offering the new service on the network.

To simplify users' interactions on the network, specific systems have been instantiated, such as password synchronization systems, single sign-on systems, remote access management systems, and numerous other systems designed to facilitate specific aspects of a user's interaction on the network. Unfortunately, this approach, while enhancing the network experience for the user, does not facilitate deployment of new services on the network, since identity management subsystems must still be developed whenever a service is to be instantiated on the network.

### SUMMARY OF THE INVENTION

The present invention overcomes these and other drawbacks by providing a centralized identity management infrastructure that is configured to provide identity management services to network resources. This enables maintenance costs associated with identity management to be reduced, accelerates dissemination of changes to identity information on the network, and facilitates deployment of new services on the network by allowing the new services to rely on the central identity management system.

According to an embodiment of the invention, an identity management infrastructure includes a set of dynamically configured client interfaces that communicate with a data assess daemon. The data access daemon processes and fulfils requests by communicating with third party databases via a data access layer containing APIs that allow the data access daemon to communicate with the databases. Providing a self-configuring user interface facilitates rapid creation of network services, and allows the services to be modified without requiring extensive changes to the user interface. Utilizing a data access layer to separate the data access daemon from the data directories allows the directories to be modified without affecting the data access daemon or the manner in which the application interfaces with the identity management infrastructure. Common data format schemas facilitates deployment of new services on the network by allowing services to be defined to take advantage of the features provided by the identity management infrastructure.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of an identity management infrastructure according to an embodiment of the invention;

FIGS. 2 and 3 are functional block diagrams of identity management infrastructures and identity transactions according to embodiments of the invention;

FIGS. 4-7 are block diagrams illustrating a self-configuring user interface according to an embodiment of the invention;

FIG. 8 is a flow chart of an example of software that may be utilized to implement an embodiment of the invention; and

FIG. 9 is a functional block diagram of a network device incorporating an identity management infrastructure according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

As described in detail below, according to embodiments of the invention, identity management may be performed by a centralized identity management service. Centralizing identity management allows services to offload responsibility for identity management to reduce maintenance costs associated with identity management and to facilitate dissemination of changes to privilege or other identity information on the network. Additionally, centralizing identity management through an identity management infrastructure and common data format schemas facilitates deployment of new services on the network, since it is not necessary for the new service to attend to identity management prior to instantiation on the network.

According to an embodiment of the invention, the identity management infrastructure includes a set of dynamically configured client interfaces that communicate with a data assess daemon. The data access daemon employs a pluggable data access layer module to communicate with third party databases which store the information. Providing a self-configuring user interface facilitates rapid creation of network services and allows for modifications to the services without requiring extensive changes to the user interface. Utilizing a data access layer to separate the data access daemon from the data directories allows the directories to be modified without affecting the data access daemon.

In the embodiments described below, there are two types of data structures: service structures, and meta data structures. The meta data entries describe how data is to be described for a particular service and other aspects of the service. The service structures contain actual data for use by particular users of the service. The identity management infrastructure (IMI) provides a standardized way of storing meta data entries and service registration data to enable services to rapidly take advantage of the identity management services provided by the identity management infrastructure.

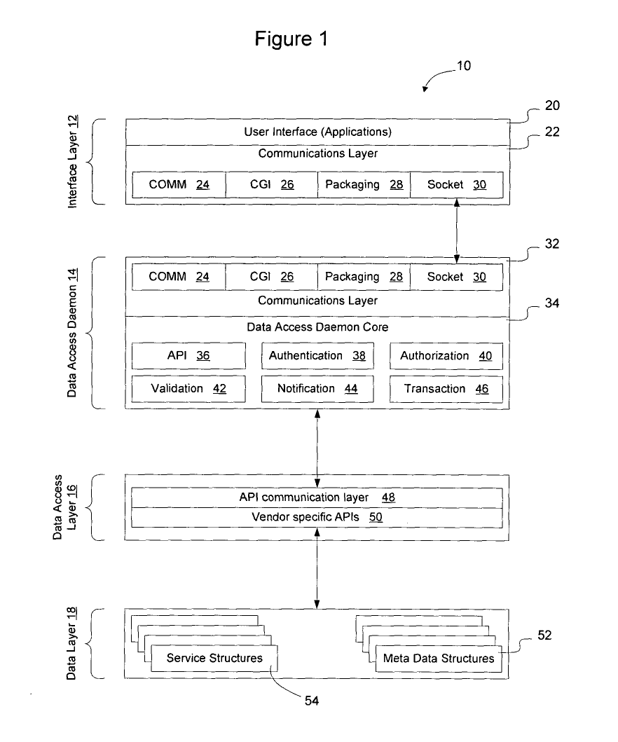

FIG. 1 illustrates an identity management infrastructure 10 according to an embodiment of the invention. As shown in FIG. 1, the identity management infrastructure (IMI) 10 includes an interface layer 12 configured to interface with identity management infrastructure client applications. The interface layer communicates with a data access daemon 14 configured to process requests from client applications and implement the requests on databases. A data access layer 16 interfaces between the data access daemon 14 and databases and attendant database management software in a data layer 18. The data access layer 16 is interposed between the data access daemon and data layer to allow the technology deployed in the data layer to be modified without affecting the operation of the data access daemon. Each layer will be discussed in greater detail below.

Interface Layer

The interface layer includes an user interface 20 which enables IMI clients to interact with the IMI, and a communications layer 22 which facilitates communication between the user interface and the data access daemon 14. The user interface 20 may be formed as a command line interface configured to process singular or bulk transactions, or as an user interface having features in addition to those provided by a command line interface.

According to one embodiment of the invention, the interface layer 12 includes a self configuring dynamic user interface which automatically self-configures and adjusts to create an identity management interface on demand to display identity management information to the requesting user of the client application. The ability of the user interface to self-configure to accommodate the requirements of the client application enables new services to be deployed on the network without requiring the developer to create an user interface to allow users to manage identity information for the new service. Similarly, the ability of the user interface to self-configure allows instantiated services to be modified without concern as to how the modifications will affect user interface.

The IMI user interface is dynamically configured upon start-up. When a user chooses to interact with a different service, the IMI user interface automatically configures itself to display the fields and buttons required for the user to interact with that service. It does this by accessing IMI meta data and retrieving the service related meta data. The user interface is then configured by the identity management infrastructure 10 for each application depending on the data display and data capture requirements of that particular application. The user interfaces 20 are created using meta data structures (discussed below) contained in the data layer 18.

The interface layer 12 also includes a communications layer 22 configured to interface with the data access daemon 14 locally or across a network. The communications layer 22 forms a module that is integrated with client processes seeking to access the IMI. The module standardizes the interfaces and mechanisms by which IMI client processes and the data access daemon 14 communicate. The communications layer primarily includes four modules (COMM, package, CGI, and socket). A standard data class is used to pass data from the COMM module to the IMI API layer. Optionally, the communications layer could be replaced by a CORBA or Java RMI implementation if desired, and the invention is not limited to any specific communications layer. The communications layer is also included in the data access daemon 14 (discussed below).

In the embodiment illustrated in FIG. 1, the communications interface module (COMM) 24 establishes a communications link between the IMI client application and the data access daemon 14. When implemented as part of the data access daemon 14, the COMM module performs send and receive operations. As part of the interface layer, the COMM module 24 adds additional functionality to establish a connection to a waiting data access daemon 14.

The CGI module 26 is called by the COMM module to convert text based data into a string which loosely follows the CGI standard. The CGI string is then transmitted across to the IMI client or data access daemon (depending on the direction of communication), where it is converted back into a data array for processing.

The packaging module 28 is called by the COMM module and packages the data for transmission. The packaging process escapes any special characters which may interfere with the data transmission, and includes packet header and end characters which indicate the beginning and end of a transmission. This allows the communication slayer to ensure it has received the entire transmitted message. The socket module 30 is called by the COMM module to actually transmit and receive data from the network.

Data Access Daemon

The data access daemon 14 is an object-oriented daemon including a communications layer 32 (discussed below) configured to communicate with the interface layer 12, and a data access daemon core 34 which contains modules configured to perform aspects of the identity management services and to interface with the other constructs in the IMI 10. One or more modules in the data access daemon core 34 enable the data access daemon to perform functions such as data manipulation, user authentication, user authorization, service data validation, external transaction processing, internal communication with the data directories and user interfaces, user notification, and any desired functions. The invention is not limited to a core that performs this specific set of functions, as additional or alternative functionality may be provided as well.

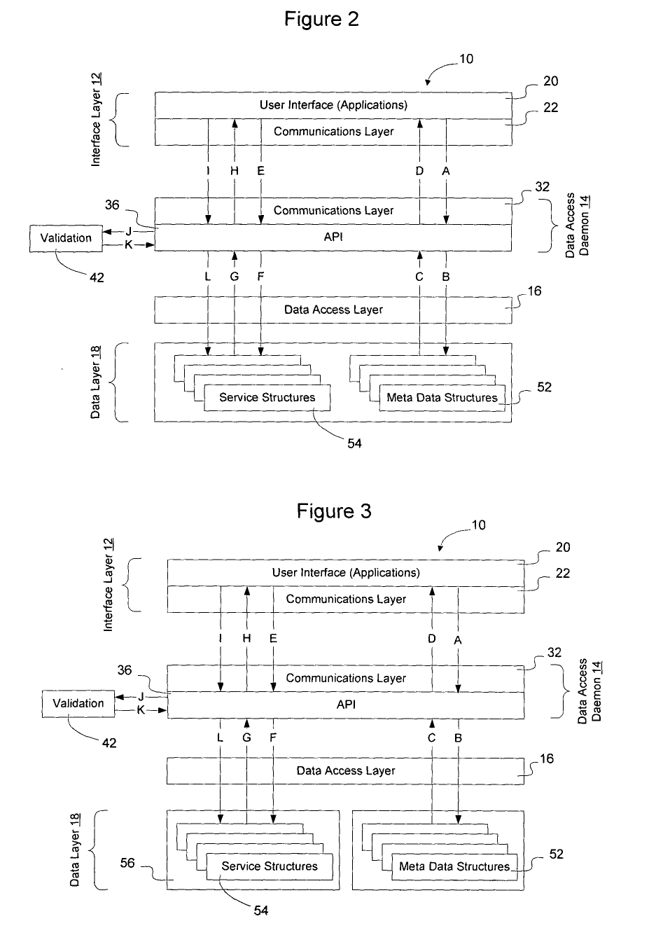

The data access daemon core includes an API 36 that is configured to receive requests from the interface layer, and interface with the data access layer 16 to fulfill the requests from directories in the data layer 18. Example of how data may be accessed by an application is discussed below in connection with FIGS. 2-3.

The IMI API module 36 provides a consistent interface to data directories for services using the IMI. The API provides a number of data manipulation methods to read, insert, update, and delete data from the various service structures. The API does not communicate directly with the data directory. Rather, communication with the directories is performed via the data access layer 16 (discussed below). The API module 36 also links a number of support modules, such as an authentication module 38, an authorization module 40, a validation module 42, a notification module 44, a transaction module 46, and other modules required to perform transactions. The invention is not limited to the specific illustrated set of support modules contained in the data access daemon core, as one or more of the functions performed by the support modules may be provided to the IMI 10 by other network services.

Authentication Module

The authentication module 38 performs a basic authentication check with the user supplied credentials. The authentication module may communicate with a password synchronization service or other password service to obtain authentication services from other authentication services on the network. The authentication module, in one embodiment, is not really linked to the data access daemon API, but to the shell code which encompasses the IMI API module.

Users of the IMI may be registered and supplied with IMI user IDs and passwords, which are stored in encrypted form within the IMI password service, and utilized to perform native authentication services. Optionally, an external authentication mechanism may be integrated into the authentication module to provide remote authentication services. If both types of authentication are available, the IMI may first attempt to authenticate an user using remote authentication. If that fails, the IMI may attempt to authenticate the user utilizing native authentication. Where the user is not able to be authenticated by either mechanism, the user will be denied access and not allowed to avail itself of the IMI services.

Authorization Module

The authorization module 40 is linked into the IMI API module. The authorization module checks to ascertain what services are available to a particular user, and what operations the user can perform in those services. The authorization module interacts with both the IMI API module and the data access layer.

The authentication and authorization information may be utilized to prevent access to the identity management infrastructure or may be used to prevent the user from performing specific transactions on the IMI that are not permitted given the user's level of authentication or authorization. For example, it may be that a particular user has “read only” privileges on the identity management infrastructure for a given application. The identity management infrastructure, in this example, would use the authorization and/or authentication information to permit the user to perform read requests on the system, but will deny the user the ability to perform write requests on the system.

According to one embodiment of the invention, an IMI service access structure stores user authorization information, which defines the level of user access for the user on the various applications that utilize the IMI for identity management services. Typically, this structure will have one registration per service per user. If a user does not have a registration for a particular service, the user has no access to that network service. An IMI service registration lookup structure, in this embodiment, provides a central catalog of owned service registrations to facilitate identification of available services available to the user.

Validation Module

The IMI utilizes a validation module 42 to perform data validation. The IMI data and services validation rules, business rules, and edit checks are typically done by plug-in programs or modules stored outside of the data directory. These programs are maintained in a separate directory and are linked to the IMI as needed. This allows a programmer to insert new edit checks or make changes to any existing edit check routine while the IMI is servicing users without affecting the user community. The IMI also provides a validation check against a relational database table. The IMI utilizes the meta information to determine what type of validation is to be performed and what validation program or SQL query to call for the specific transaction being validated.

Data validation is responsible for verifying data quality and limiting data errors by reducing the amount of entry and thinking involved in creating or changing a registration. Validation may be performed on data inserts, updates, deletes, or any other transactions. Different types of validations may be used as well. For example, the validation may occur through the use of a service button limiting the number of acceptable choices, through the input of default values, or by checking the data or performing other operations on the data.

Data validation is used to validate the data in a change request before the change is made in the database. The input data is used go generate output data. If the output data contains an error, then the validation will fail. Optionally, all validations associated with a service may be executed, even if the first one fails, to allow a full error report to be generated to allow the user to correct all errors at once, rather than one at a time.

Notification Module

The IMI may include a notification module 44 enable a specified list of users to be notified when transactions are processed by the IMI, such as when a registration for a particular service is created, updated, or deleted. The IMI client interface may also allow the user to specify additional persons to be notified upon completion or during a transaction on the IMI. The notification information, along with the registration, is passed back to the data access daemon, where a notification transaction is generated with the user-supplied and service definition receiver list.

Transaction Module

Transactions may require action by non-IMI processes. To accommodate these transactions, a transaction module 46 creates a transaction and writes that transaction to the IMI transaction queue to be processed by one or more non-IMI processes. A transaction typically includes transaction header information attached to a set of entries providing the old and new values of the processed registration. Optionally, a notification receiver list may be included to specify parties that should be notified of the external transaction.

A service transaction queue is a queue structure that stores transactions. Other non-IMI processes can access the queue using the vendor supplied directory access APIs. This allows third parties to process transactions created by the IMI without having to integrate with the data access layer or understand the IMI architecture.

Data Access Layer

The data access daemon 14 interfaces with a data access layer 16 configured to abstract the data access daemon from the data layer 18, to enable the technology used to implement the data layer to change without affecting the data access daemon 14 or the interface layer 12. Communication between the data access daemon 14 and the data access layer 16 may be via a proprietary or standardized protocol.

The data access layer 16 is the communications layer used by the data access daemon 14 to access service structures and meta data stored in the directory (discussed below). The data access layer 16 contains an API communication layer 48 containing operations familiar to the data access daemon API 36, and hides the vendor specific directory APIs 50 from the data access daemon 14. the data access layer 16 makes a common set of APIs available to the data access daemon 14 and uses the vendor supplied APIs 50 to perform the necessary database operations, such as connecting to the database, reading, writing, and error handling. The data access layer 16 may be linked to the data directories via Embedded Structured Query Language (ESQL), Open DataBase Connectivity (ODBC), Java DataBase Connectivity (JDBC), Lightweight Data Access Protocol (LDAP), or any other supplied interfaces. According to an embodiment of the invention, the API communication layer 48 in the data access layer 16 supplies the following public interfaces to be used by the IMI API 36:

TABLE I
Data Access Layer Interfaces

| Element Name | Description |
|---|---|
| Session | Establishes a connection to the directory and |
| | opens a session |
| Open | Opens a new operation |
| Close | Closes an opened operation |
| Select | Selects registrations into a select set |
| | based on search criteria |
| Fetch | Fetches a registration from a select set |
| Insert | Inserts a new registration into an existing select set |
| Apply | Applies changes made to a select set |
| | back into the director |
| Remove | Removes a registration from a select set |
| Restore | Restores a registration which was changed or removed |
| | (undo) |
| GetSelecSet | Returns the entire select set |
| GetField | Returns the value of a field selected from a registration |
| SetField | Sets the value of a specified field within a registration |
| Commit | Commits changes applied back to the data directory |
| Err | Returns the last error reported by the data directory |

The vendor specific APIs 50 provide basic insert, update, delete, and error handling functionality to the directory. Utilizing a data access layer between the data access daemon 14 and the data layer 16 allows the directory technology to change independently from the directory access daemon and client interface software.

Data Layer

The data layer 16 includes at least two types of data structures: meta data structures 52 and service structures 54. As described in greater detail below, the meta data structures 52 define what the data should look like for a particular application and is used to configure the user interface and access and format information for use by a particular application. The service structures 54 contain the actual data that will be used by the application and displayed to the user. The service structures may be maintained by the IMI or may be maintained by one or more other services on the network.

Transactions

FIG. 2 illustrates an example of a transaction on the IMI, as illustrated by arrows numbered A through L. Assume, for this example, that an user wishes to display and modify identification information for a particular application. For purposes of this example, it will be assumed that the user has been authenticated and authorized to perform the requested transactions.

To begin the transaction, the user initiates a request for access to the identity management infrastructure for a particular application by sending a request to the API (A) identifying the application and the user. The API processes the request and sends a request to obtain the meta data structure associated with the application from the meta data structures database 52 (B). The meta data structure record is returned to the API (C) and used by the API to create an user interface for the particular application (D). The user interface is defined by the meta data structure and self-configures (described below) to accommodate the data fields that will need to be made available to the user.

After the identity management infrastructure has created an user interface, the user inputs information to request particular information. For example, the user may wish to view identification information currently associated with the user for the particular application. Accordingly, the user sends a read request (E) to the API 36 requesting the API to obtain the required data from the service structures database 54. Optionally, the identity management infrastructure may obtain data associated with the user from the service structures database automatically and display the user specific information in the user interface upon creation. The API requests the data from the services structures database (F) and receives the data (G) which is then passed to the user (H) and displayed on the user interface.

If the user wishes to change data contained in the service structure, the user may send a write request (I) to the API 36 requesting that the API affect a modification to the user's data contained in the service structure. The API, upon receipt of a write request, passes the write request, data, and optionally meta data structures information to be validated (J). If the data is validated such that the transaction can continue, the API sends a write request (L) via the data access layer to the services structures database to cause the write request to be affected in the services structures database 54. Optionally, a write confirmation (not shown) may be presented to the user via the notification module once the change has been made in the service structures database 54.

The IMI may store data in its own databases, such as the meta data structures database 52 and the service structures database 54, or may perform services on behalf of other network services and pass the data back to those services upon completion of a transaction. FIG. 3 illustrates one embodiment in which the IMI performs services on behalf of another network service and the service structures database is maintained by another network service 56. In this embodiment, the IMI optionally may store a transitive service record to maintain a record of which transactions were processed on behalf of the other network services.

Data Structures

The identity management infrastructure (IMI) provides a standardized way of storing meta data entries and service registration data. In the embodiments described below, there are two types of data structures: service structures, and meta data structures. The data structures described below are specific examples of data structures that may be used to implement embodiments of the invention. The invention is not limited to these particular data structures but rather extends to all data structures that enable the features of the invention to be implemented.

Service Structures.

Service structures are formatted according to a service structure schema, one example of which is set forth below in Table II. The service structures contain data associated with particular entries, for example identification information associated with a particular user. By utilizing a standard schema to create service structures entries, the entries from multiple services may be stored in the same service structures database thus minimizing the number of databases that must be maintained. Additionally, the data may be shared between services, where desired, allowing modifications to identification data to be propagated across the network quickly and with minimal effort. The service structure schema forms the basis of the IMI framework and is also used in part to define the meta data structures.

TABLE II
Service Registration Schema

| Element Name | Description |
|---|---|
| Service_id | IMI service identifier of the service |
| Service_index | A unique index assigned to each record/registration |
| Reg_owner | ID of the person who owns the registration |
| Reg_user | ID of the person who is authorized to use the info in this |
| | registration |
| Element1 | The first data element to be stored |
| Element2 | The second data element to be stored |
| Element3 | The third data element to be stored |
| Record_user | The ID of the person who last changed this service |
| | registration entry |
| Record_owner | Category/organization of the user making the last change |
| Record_date | The date of the last change made |

Each service created using the schema has a coexisting history structure associated with it. The history structure provides audit data and statistical information. The history structure is populated with data whenever there is an insert, update, or delete performed in the related service.

Meta Data Structures

Meta data structures are used to store meta data. These structures provide IMI service configuration and privilege management data. Most IMI meta data structures are formed from the service structures schema to enable easy schema maintenance and to allow the same interface software to create and maintain both the service structures data and the meta data. Utilizing meta data schemas enable the IMI to be agnostic as to the underlying database technology.

Service Definition

When a new service is to be added to the IMI, a new service definition is created using a service definition schema, one example of which is set forth below in Table III. This service definition is stored in the meta data structures and used by the IMI to enable users to interface with the new service.

TABLE III
Service Definition Schema

| Element Name | Description |
|---|---|
| Service_id | IMI service identifier of the service |
| Service_index | A unique index assigned to each record/registration |
| Reg_owner | ID of the person who owns the registration (not used) |
| Reg_user | ID of the person who is authorized to use the info in this |
| | registration (not used) |
| Servid | The identifier assigned to the service (internal use) |
| Service_name | The title/display name assigned to the service |
| Maxtor | The maximum number of registrations the service may |
| | contain |
| Maxindv | The maximum unique individual entries the service may |
| | contain |
| Service_type | Service flags which define interface behavior |
| Field_count | Number of service elements contained in this service |
| Prererq | The service ID of the prerequisite service registration |
| | required |
| Chain | The service id this service is closely linked to |
| Service_owner | The id of the person who owns this service |
| Description | A description of the service and its use |
| Record_user | The ID of the person who last changed |
| | this service definition entry |
| Record_owner | Category/organization of the user making the last change |
| Record_date | The date of the last change made |

Service Field Definitions

Service field definitions define how each data element for each IMI service is displayed and handled by the IMI interfaces. The service field definition schema is a meta data structure. One example of a service field definition schema is described in Table IV:

TABLE IV
Service Field Definition Schema

| Element Name | Description |
|---|---|
| Service_id | IMI service identifier of the service |
| Service_index | A unique index assigned to each record/registration |
| Reg_owner | ID of the person who owns the registration (not used) |
| Reg_user | ID of the person who is authorized to use the info in this |
| | registration (not used) |
| Servid | The identifier assigned to the service (internal use) |
| Fieldid | A unique id assigned to the field in the service |
| Name | Internal name of the field |
| Mode | A series of 1 character flags defining field behavior to |
| | interfaces |
| Width | Max width of field |
| Description | Description of field and its use |
| Fieldscr | Attribute used to indicate the source of data for the field |
| Ord | Processing order of this field |
| Xpos | Starting x position on user interface of field |
| Ypos | Starting Y position on user interface of field |
| Xsize | Max display width of field |
| Ysize | Max display height of field |
| Xstrad | Number of field positions to occupy horizontally on user |
| | interface |
| Ystrad | Number of field positions to occupy vertically on user |
| | interface |
| Record_user | The ID of the person who last changed this |
| | service definition entry |
| Record_owner | Category/organization of the user making the last change |
| Record_date | The date of the last change made |

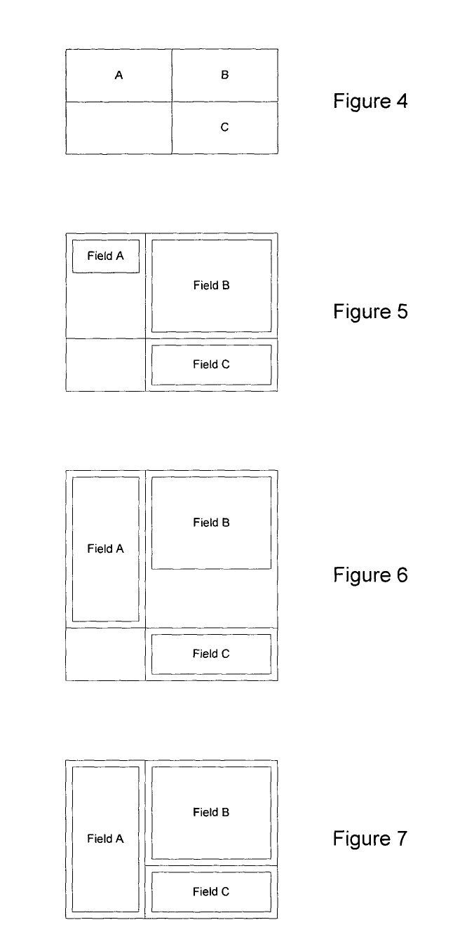

The x/y position, size, and straddle attributes define the field display characteristics which allows the IMI to dynamically generate a user interface for the service. The user interface according to an embodiment of the invention displays fields in an invisible grid that has flexible row and column sizes. The row and column sizes change based upon the size of the largest field cell in that row or column. FIGS. 4-7 illustrate how the flexible grid may be used to lay out an user interface according to an embodiment of the invention.

Assume, for this example, that there are three fields, A, B, and C, that are to be displayed on the user interface in the positions shown in FIG. 4. The sizes of the fields may all be different, due to the display type functions. For example, field A may be a single line text field 5 characters wide, Field B may be a 10 character by 3 line multi-line text field, and Field C may be a selection list. Using the service field definition for each field, the invisible grid is able to reshape itself and the user interface will take on the appearance shown in FIG. 5. As shown in FIG. 5, the grid has changed shape to accommodate the fields it contains.

Assume now that Field A is changed to be a multi-line text field with 15 lines. The user interface will automatically readjust itself to take on the appearance shown in FIG. 6. If, however, the ystrad attribute is set to “2” the grid will allow Field A to straddle two fields in the Y direction. Thus, the user interface will change so that Field A straddles both Fields B and C as illustrated in FIG. 7.

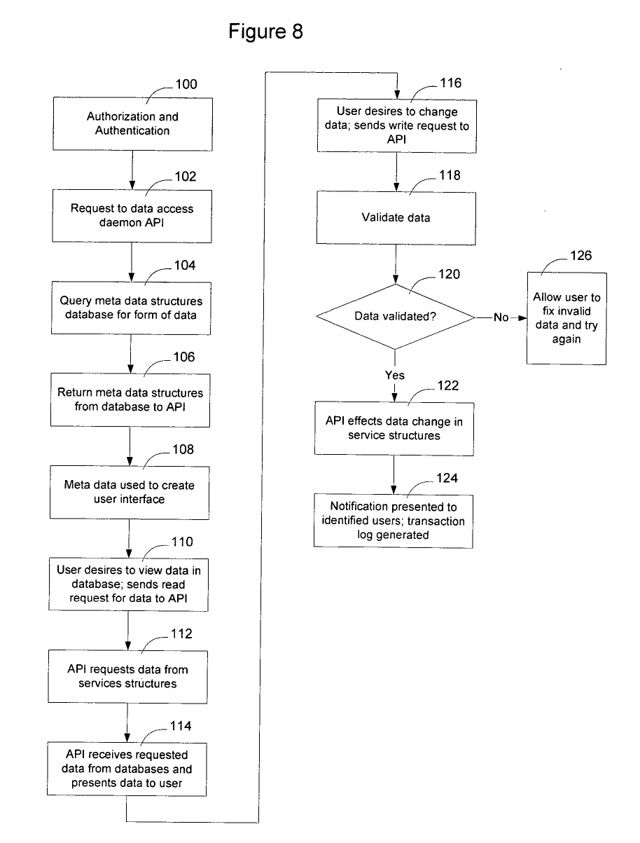

FIG. 8 illustrates a flowchart of one example of software configured to implement transactions on the identity management infrastructure 10. As shown in FIG. 8, when an user wishes to perform a transaction on the identity management infrastructure (IMI), the software first communicates with the IMI to secure the appropriate level of authentication and authorization required to perform the transaction (100). Optionally, the authentication and authorization portions may be performed by other software or hardware modules on the network and the invention is not limited to software that participates in the authentication and/or authorization processes.

The software then sends a request to the data access daemon API (102). The data access daemon API receives the request and queries the meta data structures database (104) to obtain a meta data structure associated with the service through which the user accessed the IMI. The meta data structure(s) are returned from the database to the data access daemon (106) and the meta data is used to create an user interface (108). The user interface may control the user's actions on the IMI by only presenting fields containing viewable or modifiable identity information, which may depend on the user's authorization level or other attributes about the user.

If the user desires to view the current identity management information accessible through the user interface, the user sends a read request for data to the API (110). The API processes the read request and requests the appropriate data from the service structures (112). The API receives the requested data and presents the data to the user over the user interface (114).

If the user desires to modify information in the identity management infrastructure database, the user sends a write request to the API (116). The write request contains whatever data is required by the specific implementation, such as the new data and any attendant information required to verify the information. The API sends the write request to validation module 42 to be validated (118) and waits for the data to be validated (120). If the data is validated, the API effects the data change in the service structures (122) and performs whatever notification processes are required according to the meta data and user instructions (124). The software will also generate one or more transaction logs to enable database changes to be traced at a later time. If the data is not validated (126) the user may be presented with an option to fix the submitted data and retry the write transaction.

The IMI may be used to facilitate many aspects of identity management on the network. For example, the IMI may provide a centralized identity management system. Alternatively, the IMI may be utilized as a pluggable module to provide a suite of user, network, and corporate resource provisioning services that may be added to services as they are deployed on the network. In either embodiment, the IMI may provide automated account and user application access and a centralized resource termination/securing interface to revoke resource and access rights on the network. Providing a central facility to revoke access for a particular user to network resources and ultimately erase the user's network identification enables a network administrator to secure the network from an employee upon termination or when it becomes otherwise necessary to revoke privileges for a user. The IMI may have multiple additional uses and the invention is not limited to these particular applications.

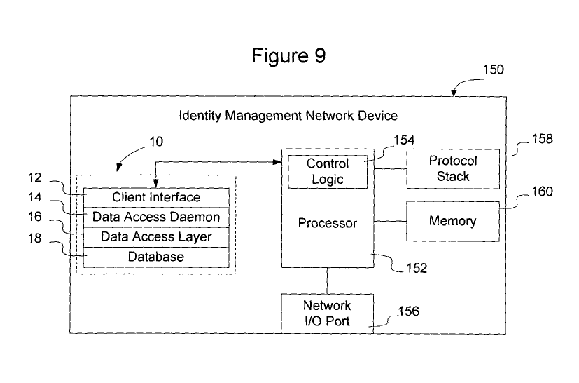

FIG. 9 illustrates an identity management network device 150 incorporating an identity management infrastructure (IMI) 10 according to an embodiment of the invention. As illustrated in FIG. 3, the network device 150 contains a processor 152 having control logic 154 configured to implement the functions ascribed to it as described above in connection with FIGS. 1-8. The network device 150 also includes network I/O ports 156 configured to enable it to communicate with domains, applications, other IMI systems, and an administrator over a network. Interactions on the network and during protocol exchanges with other network devices on the network may be facilitated through the implementation of a protocol stack 158 containing instructions and data relevant to communications protocols commonly used on the network and by the network devices.

A memory 160 contains data and/or instructions for use by the control logic to enable it to perform the functions required of it to participate in communicating with the administrators, users, and other network devices.

The control logic 154 may be implemented as a set of program instructions that are stored in a computer readable memory within the network device and executed on a microprocessor within the network device. However, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method of managing identity information on behalf of network services, the method comprising the steps of:
obtaining a first meta data record describing a first of said network services; and
utilizing said first meta data record to obtain a first service data record containing first identity management information for an user of the first network service.

2. The method of claim 1, further comprising the step of utilizing the first meta data record to create an user interface for the user of the first network service to enable the user to view said first identity management information.

3. The method of claim 1, further comprising the step of utilizing the first meta data record to create a first user interface for the user of the first network service to enable the user to modify said first identity management information.

4. The method of claim 2, wherein the first user interface is dynamically configured during creation according to field information contained in the first meta data record.

5. The method of claim 1, further comprising:
obtaining a second meta data record describing a second of said network services; and
utilizing said second meta data record to obtain a second service data record containing second identity management information for a second user of the second network service.

6. The method of claim 5, further comprising step of utilizing the second meta data record to create a second user interface for the user of the second network service to enable the second user to view said second identity management information.

7. The method of claim 1, wherein the first identity management information includes first network service provisioning information for the user of the first network service.

8. The method of claim 1, further comprising the step of denying access to the first network service where the first identity management information indicates that the user is not provisioned on the first network service.

9. A method of fulfilling identity management information requests from a network user, comprising:
obtaining meta data associated with a network service;
using the meta data to present an identity management user interface to an user of the network service; and
populating the identity management user interface with identity information associated with the user.

10. The method of claim 9, wherein the step of populating the identity management user interface comprises:
receiving a request for identity management information for the network service from the network user over the user interface;
obtaining the identity information associated with the network user; and
presenting the identity information to the network user via the user interface.

11. The method of claim 10, wherein the step of obtaining the identity information comprises accessing an identity information database and retrieving a service record from said identity information database containing identity information associated with the network user.

12. The method of claim 9, further comprising the step of modifying the identity information upon request of the network user.

13. The method of claim 12, wherein the step of modifying the identity information comprises writing changes to the identity information to an identity information database.

14. The method of claim 13, further comprising the step of validating at least one of the changes to the identity information and the identity information before writing the changes to the identity information to the identity information database.

15. An identity management infrastructure, comprising:
an interface layer configured to receive first identity management requests from first network users of a first network service and second identity management requests from second network users of a second network service;
a data access daemon configured to process the first and second identity management requests; and
a data access layer configured to enable the data access daemon to access identity management data from at least one identity management database in connection with processing the identity management requests.

16. The identity management infrastructure of claim 15, wherein the data access layer comprises an API configured to communicate with the data access daemon, and an API configured to communicate with the identity management database containing the identity management data.

17. The identity management infrastructure of claim 16, wherein the API is configured to communicate with the database utilizing at least one of Embedded Structured Query Language (ESQL), Open DataBase Connectivity (ODBC), Java DataBase Connectivity (JDBC), and Lightweight Data Access Protocol (LDAP).

18. The identity management infrastructure of claim 15, wherein the data access daemon comprises a communications layer configured to facilitate communications with the interface layer, and a data access daemon core configured to provide identity management services.

19. The identity management infrastructure of claim 18, wherein the data access daemon core comprises an API configured to interact with meta data structures and service structures retrieved from the identity management database.

20. The identity management infrastructure of claim 19, wherein the meta data structures describe the network services, and wherein the service structures describe identity information associated with users of the network services.

21. The identity management infrastructure of claim 18, wherein the data access daemon core further comprises an authentication module configured to authenticate the first and second network users and an authorization module configured to assess authorization levels associated with the first and second network users.

22. The identity management infrastructure of claim 18, wherein the data access daemon core further comprises a validation module configured to validate data prior to modification of data in the database.
